(19) United States
(12) Patent Application Publication
(10) Pub. No.: US 2007/0046098 A1
(43) Pub. Date: Mar. 1, 2007

(54) Vehicle stability system diagnostic method

(75) Inventors: Kenneth A. Grolle, Elyria, OH (US); Cem Hatipoglu, Rocky River, OH (US); William P. Amato, Avon, OH (US); Michael D. Tober, Bay Village, OH (US); Richard E. Beyer, Westlake, OH (US)

Correspondence Address: CALFEE HALTER & GRISWOLD, LLP, 800 SUPERIOR AVENUE, SUITE 1400, CLEVELAND, OH, 44114, US

(73) Assignee: Bendix Commercial Vehicle Systems LLC, Elyria, OH (US)

(21) Appl. No.: 11/216,848

(22) Filed: Aug. 31, 2005

(51) Int. Cl. B60T 8/88

(52) U.S. Cl. 303/122.15; 303/127

(57) ABSTRACT

An air brake system for use with a vehicle is provided. This system includes an antilock braking system component; a stability system component, wherein the stability system component works in combination with the antilock braking system component to stabilize the motion of the vehicle under predetermined conditions; and a means for automatically determining the operability of stability system component, wherein the means determining the operability of stability system component provides at least one of an audible indicator of stability system operability and an electronic indicator of stability system operability.

### BACKGROUND OF THE INVENTION

This invention relates in general to diagnostic systems for antilock/stability braking systems used with commercial vehicles such as tractors, trucks and buses, and in particular to a system and method for providing the operator of a vehicle with information as to whether or not certain components or subsystems associated with an antilock/stability brake system are functioning properly.

Antilock braking systems are electronic systems that monitor and control wheel slip during vehicle braking. Antilock braking systems can improve vehicle control during braking, and reduce stopping distances on slippery (split or low coefficient of friction) road surfaces by limiting wheel slip and minimizing lockup. Rolling wheels typically have much more traction than locked wheels. Reducing wheel slip improves vehicle stability and control during braking, since stability increases as wheel slip decreases. Antilock braking systems can be used with nearly all types of vehicles and can be successfully integrated into hydraulic and air brake systems. The National Highway Traffic Safety Administration (NHTSA) defines an antilock braking system as a portion of a service brake system that automatically controls the degree of rotational wheel slip during braking by: (i) sensing the rate of angular wheel rotation; (ii) transmitting signals regarding the rate of wheel rotation to one or more devices, which interpret these signals and generate responsive controlling output signals; and (iii) transmitting those signals to one or more devices that adjust braking forces in response to the signals.

A typical antilock braking system consists of several basic components: an electronic control unit (ECU), wheel speed sensors, modulator valves, and exciter rings. The wheel speed sensors constantly monitor the wheel speed and send electrical pulses to the ECU at a rate proportional to the wheel speed. When the pulse rates indicate impending wheel lockup, the ECU signals the modulator valves to reduce and/or hold the brake application pressure to the wheel(s) in question. The ECU then adjusts pressure to provide maximum braking without risking wheel lockup. The ECU checks itself for proper operation, and if it detects a malfunction or failure in the electrical/electronic system, it may shut down that part of the antilock braking system affected by the problem, or the entire antilock braking system, depending upon the system and the problem. A malfunction indicator lamp may light when the system has been partially or completely shut down.

In addition to a basic antilock braking system, some vehicles include additional systems or subsystems that work in combination with the antilock braking system. These additional systems may provide traction control, vehicle stability, or other benefits and they typically share certain components such as the ECU, modulator valves, pneumatic lines and electrical lines with the antilock brake system. Just as with the antilock brake system, the vehicle's operator should at all times be aware of the operability of these systems when the vehicle is in use. Because the possibility exists that various system components may have been improperly installed or incorrectly connected to one another, a need exists for a means for making the operator aware of problems with the antilock brake system and any associated systems. Some antilock brake systems utilize a so-called “chuff” test to detect incorrectly wired modulator valves. This test is based on the difference in the exhaust sound generated by a correctly wired modulator versus an incorrectly wired modulator. While basically effective for detecting problems with the antilock brakes, this test is not capable of detecting problems with other systems or subsystems associated with the antilock braking system. Thus, a need exists for a system and method for diagnosing the operability of a secondary system, such as a stability system, that works in combination with a vehicle's primary antilock brake system.

### SUMMARY OF THE INVENTION

Deficiencies in and of the prior art are overcome by the present invention, the exemplary embodiment of which provides an air brake system for use with a vehicle. An exemplary embodiment of this system includes an antilock system component, a stability system component, and a means for determining the operability of stability system component. The antilock braking component further includes: (i) an electronic control unit; (ii) at least one antilock modulator in communication with the electronic control unit; and (iii) at least one brake in communication with the at least one antilock modulator, wherein the at least one antilock modulator controls the at least one brake in response to commands received from the electronic control. The stability system component further includes: (i) a first stability system modulator in communication with the electronic control unit and the at least one antilock modulator; (ii) a second stability system modulator in communication with the electronic control unit and the first stability system modulator; and (iii) an electronic indicator in communication with the electronic control unit. The means for determining the operability of stability system component further includes (i) introducing pressurized air into stability system component; (ii) generating feedback within stability system component by selectively energizing and de-energizing the at least one antilock modulator, the first stability system modulator, and the second stability system modulator in a predetermined sequence; (iii) analyzing the feedback with the electronic control unit to determine the operability of stability system component; and (iv) using the electronic indicator to the display the results of the feedback analysis.

Additional features and aspects of the present invention will become apparent to those of ordinary skill in the art upon reading and understanding the following detailed description of the exemplary embodiments. As will be appreciated, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description of the embodiments given below, serve to explain the principles of the invention.

FIG. 1 is a schematic illustration of a partial air brake system used with a vehicle that includes an antilock braking system.

FIG. 2 is a schematic illustration of a second embodiment of a partial air brake system used with a vehicle that includes an antilock braking system.

FIG. 3 is a schematic illustration of a third embodiment of a partial air brake system used with a vehicle that includes an antilock braking system.

FIG. 4 is a schematic illustration of a fourth embodiment of a partial air brake system used with a vehicle that includes an antilock braking system.

FIG. 5 is a schematic illustration of a fifth embodiment of a partial air brake system used with a vehicle that includes an antilock braking system.

FIG. 6A-B is a flow block diagram illustrating an exemplary stepwise method by which the electronic control unit of the system illustrated in FIG. 1 performs the testing function of the present invention.

### DETAILED DESCRIPTION OF THE INVENTION

The present invention relates to a system and method for providing the operator of a vehicle that includes an antilock braking system (ABS), such as the ABS-6 (Bendix Commercial Vehicle Systems LLC; Elyria, Ohio) and a supplemental vehicle stability system (known by such terms as “ESP” or “RSP”), with an audible and/or electronic indicator of the operability of the stability system. By providing a consistent audible “cue” to the operator each time the vehicle is started, the operator learns the “sound” of a properly operating stability system. In addition to the audible indicator, the system and method of this invention utilizes electrical feedback by way of the vehicles brake lights so that the integrity of the stability system can be self-ascertained. Thus, the exemplary embodiment is capable of detecting missing stability system valves, as well as malfunctioning valves, and/or valves that have been incorrectly wired. The exemplary embodiment of this invention includes an ABS component, a stability system component that works in combination with the ABS component, and a diagnostic test method for automatically determining the integrity and operability of the stability system component.

The ABS component of the present invention prevents wheel lock up during braking to maintain the steering and stability of the vehicle and to minimize stopping distance. In general terms, the first basic component of the exemplary ABS are the speed sensors (SS), which are located at the wheels to sense the instantaneous movement of individual wheels and to send an electrical signal directly proportional to the rotational velocity of the sensed wheel to the electronic control unit. The second basic component of the exemplary ABS is the electronic control unit (ECU), which monitors the speed sensor signals and determines when ABS intervention is required and actuates the appropriate pressure modulation valves to optimize the brake pressure. The ECU continually monitors the system to detect and warn the driver of any malfunctions. Failure specific codes are stored in the ECU and can be recalled to diagnose a failure. The third basic component of the exemplary ABS are the pressure modulation valves (PMV), which are located near the brake chambers and are controlled by the ECU to decrease, hold or allow the full applied brake pressure into the brake chamber to control the braking torque at the wheels. The ABS intervenes during braking whenever the available friction between the road and the tire of a monitored wheel is less than the braking force applied to the wheel causing the wheel to decelerate quickly (impending wheel lock).

Regarding the supplemental stability system, during stability interventions, the ECU applies the vehicle's brakes without action on the part of the driver or operator. An exemplary method for accomplishing this function utilizes an ATC valve in the front and rear brake circuits (or axle group(s)) which, when energized, supplies a reference pressure to the corresponding axle. The wheel end modulators are then used to control air pressure flow to each wheel end using the reference pressure supplied by the ATC valve. For the front and rear axle of a truck, bus, or tractor, these modulators are typically pressure modulator valves that are also used for ABS/ATC purposes. In situations where the powered unit may tow other non-powered units (e.g., tractors and trucks that can haul trailers), the stability system may apply the brakes of the towed unit as well. For this application, a PMV valve is attached to the ATC valve (which provides reference pressure to the front (or rear) axle) and modulates and controls pressure delivered to the trailer during stability interventions. A brake light switch is typically included downstream of the output of this PMV. During power-up, the stability portion of the diagnostics energizes the ATC valve to provide the reference (input) air, control the operation of the PMV, and monitor brake light status to validate the integrity of the system. For example, when the ATC is energized, if the PMV is holding, the brake lights are not expected to light. When pressure builds, the brake lights are expected to come on, and when pressure is exhausted, the brake lights are expected to go off. The status of the brake lights is available as an electrical input to the ECU, and the operator does not need to monitor the system. If the vehicle does not include a towed unit (e.g., a bus), the PMV would typically not be included. In this case, an audible signal is available and is derived from energizing and de-energizing the ATC valve.

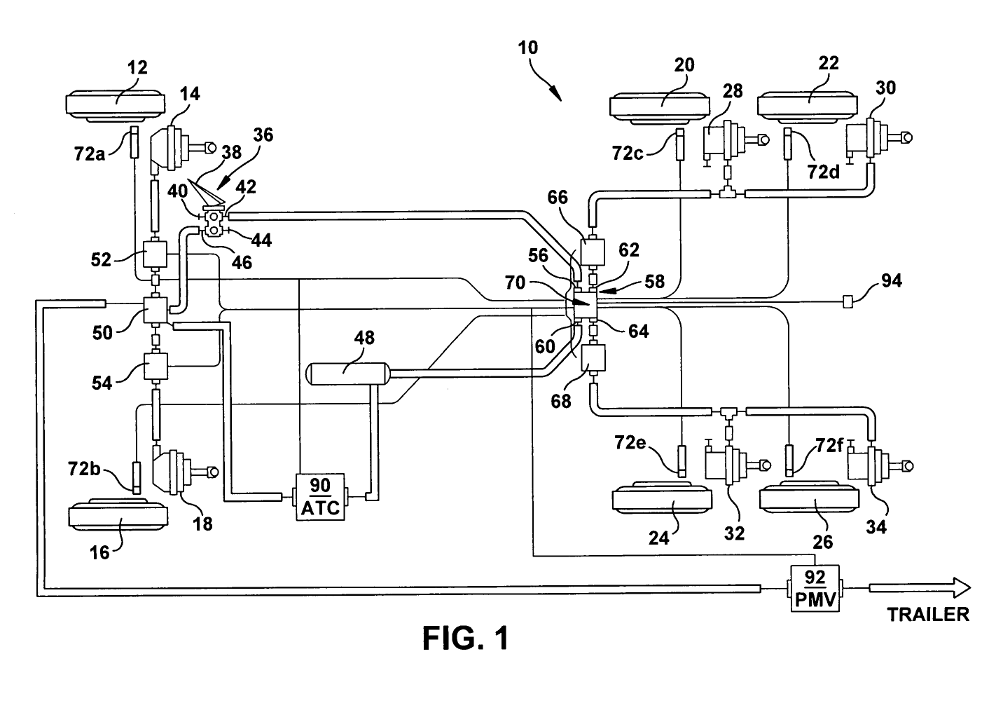

With reference to FIG. 1, an exemplary air brake system 10, includes right front wheel 12 and associated brake actuator 14, left front wheel 16 and associated brake actuator 18, and a double rear axle assembly comprising right rear wheels 20, 22, left rear wheels 24, 26 and associated tandem brake actuators 28, 30, 32, and 34, respectively. System 10 further includes an operator actuated, brake valve 36 having a treadle 38. When the treadle 38 is actuated the valve 36 permits communication between inlet port 40 and outlet port 42 and simultaneously permits communication between inlet port 44 and outlet port 46. System 10 further includes a source of air pressure, such as reservoir 48, which is charged by an air compressor operated by the vehicle engine (not shown). Port 44 communicates with the pressure source 48, but for purposes of clarity these pneumatic lines have been omitted from FIG. 1. Outlet port 46 is connected to the right and left wheel actuators 14, 18 through a quick release or relay valve 50 and right and left front wheel ABS modulators 52, 54. Outlet port 42 of brake valve 36 is connected to control port 56 of relay valve 58. Supply port 60 of relay valve 58 communicates with the pressure source 48 and outlet ports 62, 64 of relay valve 58 are connected respectively to the right rear wheel actuators 28, 30 and left rear wheel brake actuators 32, 34 through right rear wheel brake modulator 66 and left rear wheel ABS modulator 68. Typically, the electronic control unit (ECU) 70 for the braking system, which controls the ABS modulators 52, 54, 66, and 68 is housed in the cover of the relay valve 58. Speed sensors 72A-F detect the speed of the wheels with which they are associated and generate signals that are transmitted to the ECU 70. Similarly, actuating signals generated by ECU 70 when, for example, an incipient skidding condition of one of the wheels is detected are transmitted to the ABS modulators 52, 54, 66, and 68 through the leads connecting the ECU 70 and the corresponding ABS modulators.

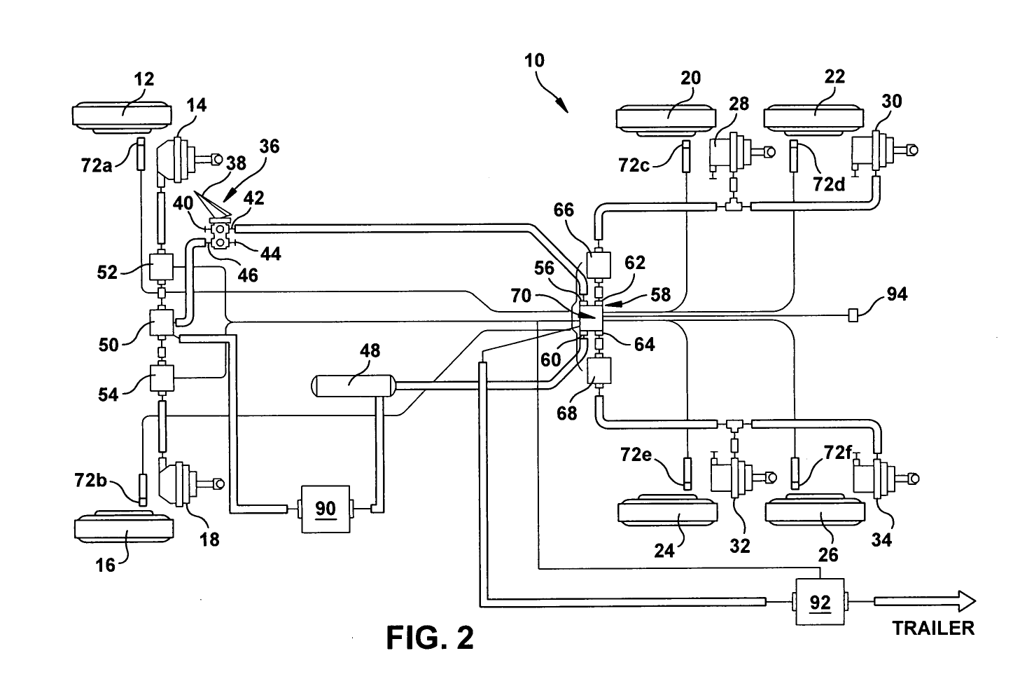

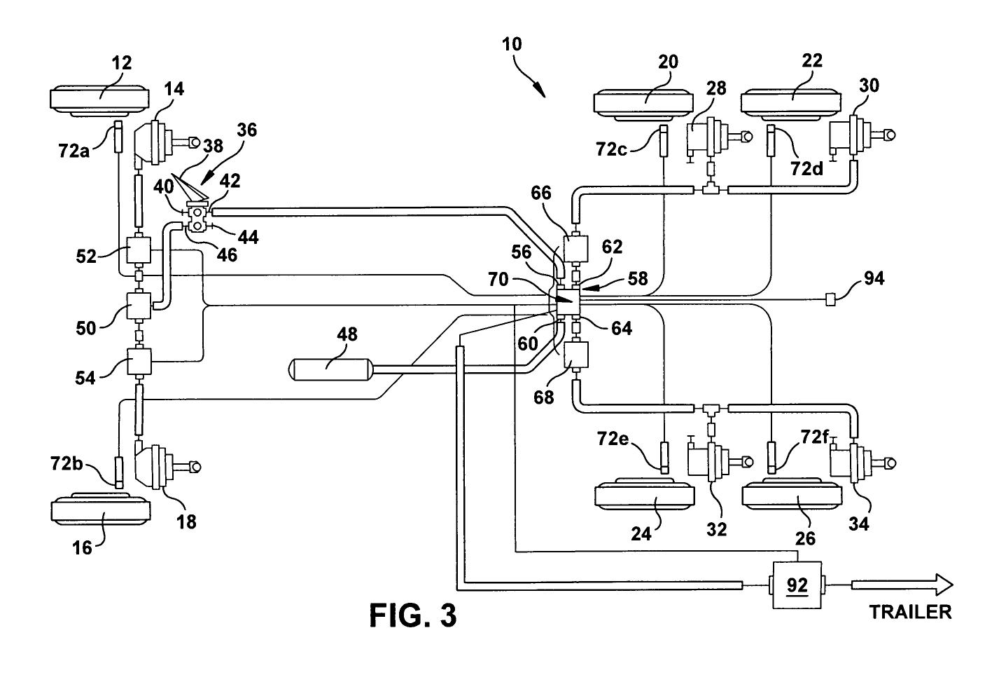

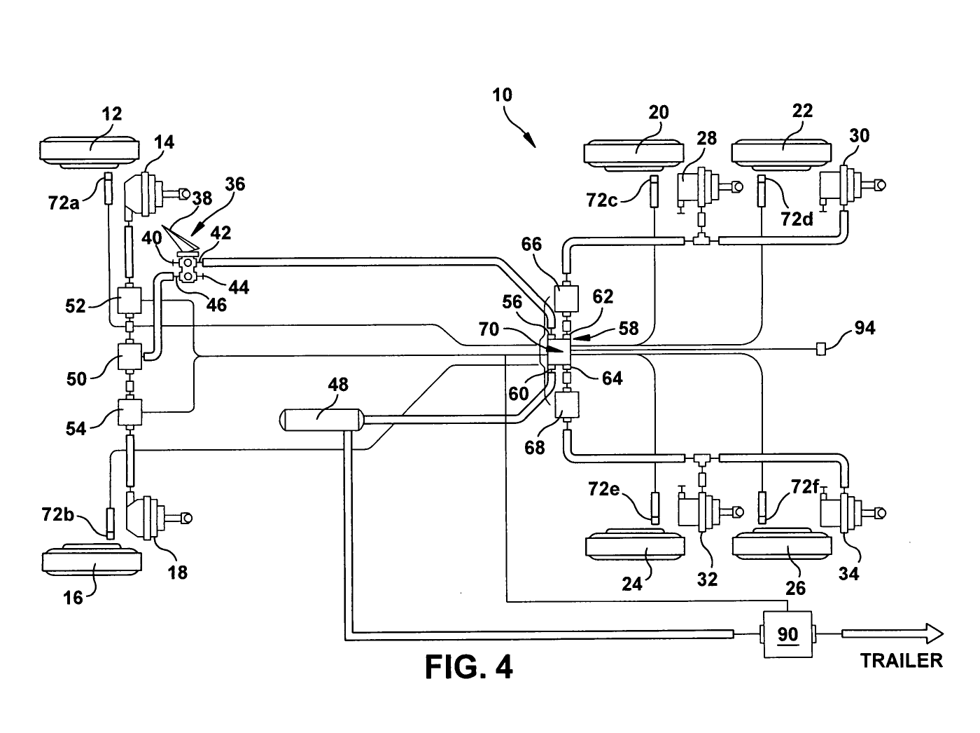

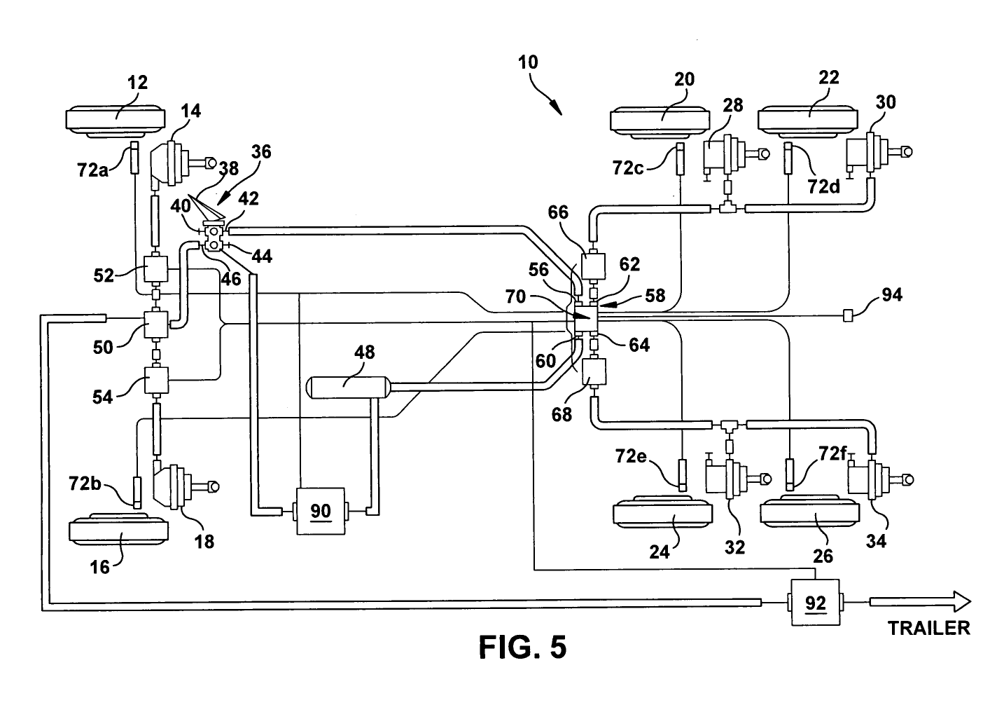

FIGS. 2-5 illustrate alternate system architectures. In the system of FIG. 2, PMV valve 92 is in communication with a rear relay valve (reference numeral 58) rather than front relay valve 50. In the system of FIG. 3, the front axle apply has been eliminated to create a generally less expensive system configuration. In the system of FIG. 4, valve 92 has been eliminated and stability traction modulator 90 is in direct communication with reservoir 48. In the system of FIG. 5, modulator 90 is in direct communication with brake valve 36. Other configurations are possible.

In the exemplary embodiments of the present invention, the ABS system continuously monitors a variety of vehicle parameters and sensors to determine if the vehicle is reaching a critical stability threshold. If this threshold is reached, the stability system component, referred to in the Figures as “ESP”, quickly and automatically intervenes to stabilize the vehicle. During operation, the ECU 70 compares performance models to the vehicle's actual movement using the wheel speed sensors of the ABS system, as well as lateral, yaw, and steering angle sensors. If the vehicle shows a tendency to leave an appropriate travel path, or if critical threshold values are approached, the system will intervene to assist the driver. In the case of a potential roll event, the system will override the throttle and quickly apply brake pressure at selected wheel ends to slow the vehicle below a critical threshold. In the case of vehicle slide, i.e., over-steer or under-steer situations, the system will reduce the throttle and then brake one or more of the “four corners” of the vehicle, in addition to potentially applying trailer brakes, thus applying a counter-force to better align the vehicle with an appropriate path of travel. For example, in an “over-steer” situation, the system applies the “outside” front brake; while in an under-steer condition, the inside rear brake is applied.

Because the stability system, i.e., ESP or RSP, provides important safety features to the vehicle and to the operator, it is highly desirable to ascertain the integrity of the system prior to operating the vehicle. The present invention provides a diagnostic test method for making this determination and providing the vehicle's operator with one or more indicators of system operability. The stability system diagnostic usually begins immediately after the ABS (regular) chuff test and is a stability system specific extension of the ABS chuff test previously discussed (see U.S. Pat. No. 6,237,401, which is hereby incorporated by reference in its entirety). By introducing just enough air pressure into the brake system to create detectable feedback, the energy introduced into the system and any motion of brake components is minimized. Advantageously, the operator does not need to apply the brakes to hear an audible signal. Without the operator's foot on the brake pedal, the brake lamp switch can be used to monitor the system. The ECU uses the switch feedback to monitor and record errors. However, if the driver leaves his foot on the brake, there is still an audible difference as the stability system test cycles through the additional steer axle and trailer stability system modulators.

If operating conditions are such that the ABS chuff test is not run, then the stability system diagnostic will also not run. In the exemplary embodiment, the stability system diagnostic differs from the ABS chuff test in regards to what the system can self-diagnose. While the ABS chuff test does not typically detect cross-wired ABS modulators, the stability system diagnostic is capable of detecting cross-wired stability system valves due to the fact that the stability system diagnostic utilizes the air pressure activated brake light switch as closed-loop feedback to make sure that the system is operating properly. The ABS chuff test relies on the operator to detect an audible difference between a correctly wired modulator and a cross-wired modulator. The stability system diagnostic also provides a distinctive audible difference between a correctly wired stability system valve and a cross-wired valve. However, the system does not depend completely on the operator's ability to hear a problem. The stability system diagnostic also has the ability to identify a “diagnostic trouble code” associated with the stability system, and can shut down the stability portion of the system if and when necessary. The stability portion of the chuff test does not run if there are active diagnostic trouble codes associated with the stability portion of the control system. The disappearance of a previously existing audible feedback is also an indicator for the operator that the stability system is no longer fully operational. A dash diagnostic trouble code indicator (not shown) in communication with ECU 70 will also be lighted in this situation.

As previously discussed, the stability system diagnostic utilizes the brake lamp pressure switch for feedback. Therefore, to prevent false test results, the ECU must monitor for driver interventions (i.e., brake applications) throughout the testing portion of the stability system diagnostic. Throughout the stability system diagnostic, pressure sensors in the driver control lines are monitored. If the ECU detects a driver intervention, then the results of the current stability system diagnostic are not used as indication of system status (good or bad). In this case, the audible ESP diagnostic results may still be valid. Additionally, once the stability system portion of the chuff tests starts, the end portion of the stability system diagnostic cannot typically be terminated (e.g., if the vehicle starts moving). The end portion of the stability system chuff exhausts any air in the system that the ESP chuff may have introduced.

With reference to FIGS. 1-5 and 6A-B, a sub-routine programmed within the ECU 70 for performing a stability system diagnostic is illustrated schematically. The system components that are typically involved in the stability system diagnostic method include the ECU 70, ABS front axle ABS modulators 52 and 54, stability system tractor modulator 90, stability system trailer modulator 92, which includes a hold solenoid and an exhaust solenoid, and brake lamp switch 94. These system components are in electrical and/or pneumatic communication with one another as illustrated in FIG. 1.

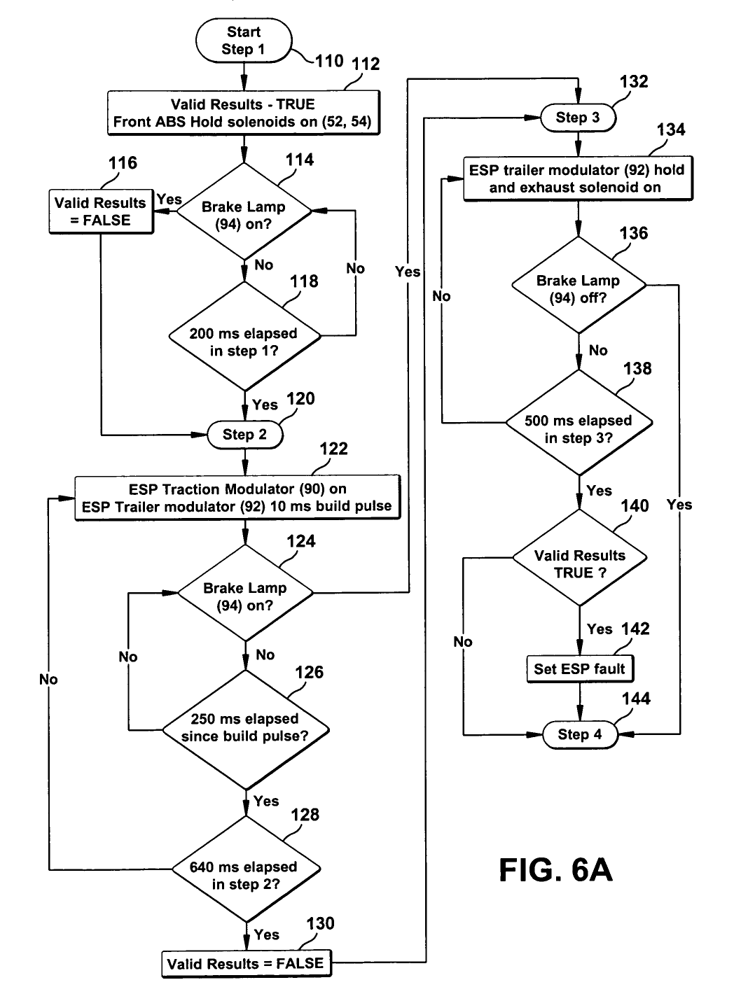

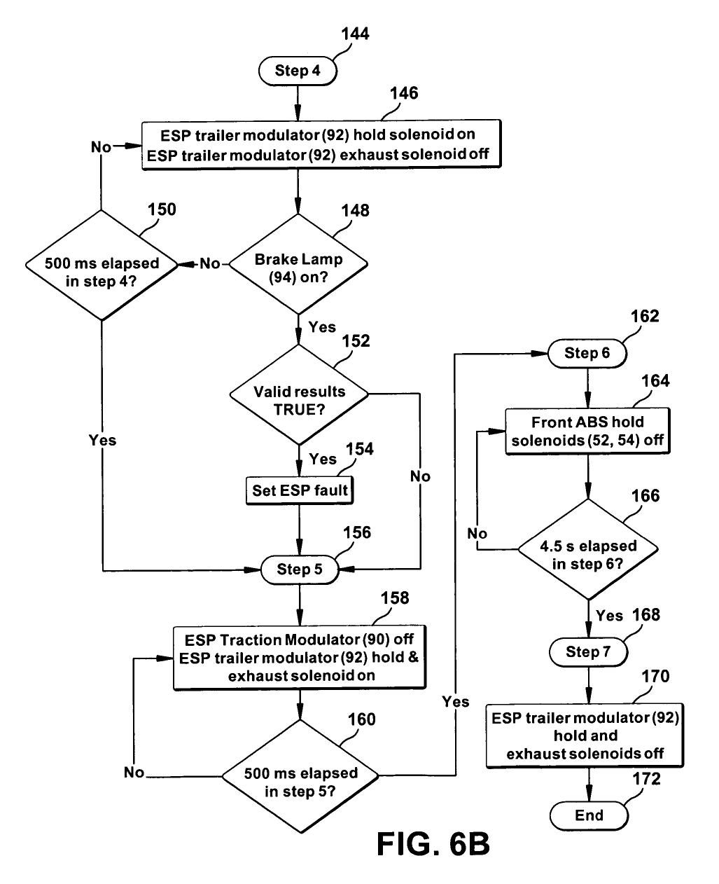

As shown in FIG. 6A, an exemplary embodiment of the vehicle stability system diagnostic, i.e., the stability system diagnostic method of the present invention begins at 110. The general purpose of Step 1 at 114 is to determine whether or not the driver is actuating the brake lamp 94 by stepping on the brake pedal. If the operator is stepping on the brake pedal, the system discounts at 116 the results of the stability system diagnostic. In the exemplary method, this step at 118 lasts a maximum of 200 ms. As soon as negative results are detected, the stability system diagnostic advances at 120 to Step 2, aborting the remaining time in this step. During Step 1, the ECU turns on the front axle ABS modulator's hold-state. The ESP front axle traction modulator is pneumatically connected to both the stability system trailer modulator 92 and the front axle ABS modulators 52, 54. It is desirable that the front axle ABS modulators 52, 54 not be permitted to pass air to the front brake chambers 14, 18. If air was allowed to the front axle brake chambers the additional noise could become confusing to the operator and would likely increase the stored pneumatic energy in the brakes and lines creating longer exhaust times. The front axle ABS modulators 52, 54 remain in the hold state until Step 6. Regarding the stability system modulators, in Step 1 the stability system steer axle traction modulator 90 is OFF; the stability system trailer modulator 92 hold solenoid is OFF; and the stability system trailer modulator 92 exhaust solenoid is OFF. Thus, none of the three stability system specific solenoids are energized. As stated, the brake light switch 94 is monitored to see if the operator is applying brake pressure. If it is detected that the brake lamps have energized, then the results of the diagnostic are not used by the ECU as indication of system status. However, the stability system diagnostic continues because the audible indicators are still valid.

The general purposes of Step 2 (FIG. 6A) at 120 is to determine (i) whether or not there is sufficient air in brake system 10 for executing the stability system diagnostic; (ii) to test the pressure activated brake lamp switch 94; and (iii) to test the ability of the stability system steer axle traction modulator 90 to supply air pressure. In the exemplary embodiment, this step lasts a maximum of 640 ms at 128. As soon as positive results are detected (brake lamp on) at 124, the stability system diagnostic advances to Step 3 at 132, aborting the remaining time in this step. During Step 2, the front axle ABS modulators 52, 54 remain in the hold-state, the stability system steer axle traction modulator 90 is ON; the stability system trailer modulator 92 hold solenoid is ON (pulsed off 10 ms out of 250 ms at 126); and the stability system trailer modulator 92 exhaust solenoid is OFF. The stability system front axle traction modulator 90 is energized, supplying air pressure to the stability system trailer modulator 92. The stability system trailer modulator 92 is energized in a series (maximum of three, typically) of 10 ms pulses with 240 ms of off time between pulses. This step charges the trailer system just enough to turn on the brake lamp pressure switch 94 while minimizing any movement in any attached trailers brake chambers. If it is detected that the pressure activated brake lamp switch 94 has come on, the conclusion is that: (i) there is enough air in the system to use the results of the stability system diagnostic as an indication of system status; (ii) the pressure activated brake lamp switch 94 is functioning; and (iii) the stability system steer axle traction modulator 90 can supply air (assuming the driver is still not interfering, which is constantly monitored).

The general purpose of Step 3 (FIG. 6A) at 132 is to test the ability of the stability system trailer modulator 92 to exhaust. This step typically lasts a maximum of 500 ms at 138. As soon as positive results are seen at 136 (brake lamp off) the stability system diagnostic advances to Step 4 at 144, aborting any remaining time in Step 3. In this step, the front axle ABS modulators 52, 54 remain in the hold-state; the stability system steer axle traction modulator 90 is ON; the stability system trailer modulator 92 hold solenoid is ON; and the stability system trailer modulator exhaust solenoid is ON. The stability system front axle traction modulator 90 remains energized, and continues to supply air pressure to the stability system trailer modulator 92. Both solenoids of the stability system trailer modulator 92 are energized at 134. This is the exhaust function of the modulator. The hold solenoid blocks the supply air, and the exhaust solenoids exhausts downstream air to atmosphere. If it is detected that the pressure activated brake lamp has gone off, then the conclusion at 140 is that stability system trailer modulator 92 does have the ability to perform the exhaust function at the system sets the stability system fault and 142.

With reference to FIG. 6B, the general purpose of Step 4 at 144 is to test the ability of the stability system trailer modulator 92 to hold. This step typically lasts a maximum of 500 ms at 150. If negative results are detected (brake lamp on), the stability system diagnostic advances to Step 5 at 156, aborting any remaining time in this step. During Step 5, the front axle ABS modulators 52, 54 remain in the hold-state; the stability system steer axle traction modulator 90 is ON; the stability system trailer modulator 92 hold solenoid is ON at 146; and the stability system trailer modulator exhaust solenoid is OFF at 146. With the stability system trailer modulator exhaust off, and pressure at the input from the stability system steer axle traction modulator, the activated hold solenoid should block air pressure, keeping the brake lamp switch 94 off. If no brake lamp switch activation is seen at 148 for the entire 500 ms then, the conclusion at 152 is that the stability system trailer modulator hold function is working properly. After Step 5 is complete, the stability system diagnostic is essentially complete, and the remaining steps return the brake system 10 to normal control.

Again with reference to FIG. 6B, the general purpose of Step 5 at 156 is to release air pressure in the stability system trailer modulator valve 92 and front axle ABS modulators 52, 54 that has been introduced by the activation of the stability system steer axle traction modulator 90. This prevents unwanted brake activation as the valves are de-energized. This step typically lasts about 500 ms at 160 and is not typically aborted or shortened. During this step, the front axle ABS modulators 52, 54 remain in the hold-state; the stability system steer axle traction modulator 90 is OFF; the stability system trailer modulator 92 hold solenoid is ON; and the stability system trailer modulator 92 exhaust solenoid is ON. While continuing to block air from pressurizing the rest of the system, the stability system steer axle traction modulator 90 is turned off at 158 to drain the pressure being applied to the inputs of the stability system trailer modulator 92 and the front axle ABS modulators 52, 54. Because no testing is done during this step, there are no results to interpret.

Again with reference to FIG. 6B, the general purpose of Step 6 at 162 is to release any remaining air pressure in the system introduced by the stability system diagnostic and to prevent unwanted brake activation as valves are de-energized. This step lasts about 4.5 seconds at 166 and is not typically aborted or shortened. During this step at 164, the front axle ABS modulators 52, 54 are OFF; the stability system steer axle traction modulator 90 is OFF; the stability system trailer modulator 92 hold solenoid is ON; and the stability system trailer modulator 92 exhaust solenoid is ON. While continuing to block air from pressurizing the rest of the system, the stability system steer axle traction modulator 90 is turned off to drain the pressure being applied to the inputs of the stability system trailer modulator 92 and the front axle ABS modulators 52, 54. Because no testing is done during this step, there are no results to interpret.

Again with reference to FIG. 6B, the general purpose of Step 7 at 168 is to disengage the stability system trailer modulator 92 exhaust solenoid and return ABS system to normal operations. This step lasts about 5 ms and is not typically aborted or shortened. During this step, the front axle ABS modulators 52, 54 are OFF; the stability system steer axle traction modulator 90 is OFF; the stability system trailer modulator 92 hold solenoid is OFF; and the stability system trailer modulator 92 exhaust solenoid is OFF. Because no testing is done during this step, there are no results to interpret.

Each time the stability system diagnostic determines an incorrect result a stored internal counter is incremented by 5 counts. Each time the stability system diagnostic determines correct results, the same internal counter is decremented by 1 count. If the count reaches or exceeds 50, then the stability system is faulted requiring repair. Once repaired, clearing faults results in the counter being set back to 49. If the repair was not performed properly, the stability system will fault again on the very next usable stability system diagnostic. If the repair was done correctly, then the counter will slowly decrease to zero with each of the next 49 successful diagnostic tests.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. An air brake system for use with a vehicle, comprising:
(a) an antilock braking system component;
(b) a stability system component, wherein the stability system component works in combination with the antilock braking system component to stabilize the motion of the vehicle under predetermined conditions; and
(c) a means for automatically determining the operability of stability system component, wherein the means determining the operability of stability system component provides at least one of an audible indicator of stability system operability and an electronic indicator of stability system operability.

2. The air brake system of claim 1, further comprising an means for determining the operability of the antilock braking system component, and wherein the means for determining the operability of stability system component works in combination with the means for determining the operability of the antilock braking system component.

3. The air brake system of claim 1, wherein the antilock braking system component further comprises:
(a) an electronic control unit;
(b) at least one antilock modulator in communication with the electronic control unit; and
(c) at least one brake in communication with the at least one antilock modulator, wherein the at least one antilock modulator controls the at least one brake in response to commands received from the electronic control unit.

4. The air brake system of claim 3, wherein the stability system component further comprises:
(a) at least one stability system modulator in communication with the electronic control unit and the at least one antilock modulator; and
(b) an electronic indicator in communication with the electronic control unit.

5. The air brake system of claim 4, wherein the second stability system modulator further comprises a hold solenoid and an exhaust solenoid.

6. The air brake system of claim 4, wherein the electronic indicator further comprises a brake lamp.

7. The air brake system of claim 1, wherein the means for determining the operability of stability system component further comprises the introduction of pressurized air into the stability system component, and wherein the introduction of the pressurized air into the stability system component creates detectable feedback.

8. An air brake system for use with a vehicle, comprising:
(a) an antilock braking system component, wherein the antilock brake system component further comprises:
(i) an electronic control unit;
(ii) at least one antilock modulator in communication with the electronic control unit; and
(iii) at least one brake in communication with the at least one antilock modulator, wherein the at least one antilock modulator controls the at least one brake in response to commands received from the electronic control unit; and
(b) a stability system component, wherein the stability system component operates in combination with the antilock braking system component to stabilize the motion of the vehicle under predetermined conditions, and wherein the stability system component further comprises:
(i) at least one stability system modulator in communication with the electronic control unit and the at least one antilock modulator; and
(ii) an electronic indicator in communication with the electronic control unit; and
(c) a means for determining the operability of stability system component, wherein the means for determining the operability of stability system component provides at least one of an audible indicator of stability system operability and an electronic indicator of stability system operability.

9. The air brake system of claim 8, further comprising an means for determining the operability of the antilock braking system component, and wherein the means for determining the operability of stability system component works in combination with the means for determining the operability of the antilock braking system component.

10. The air brake system of claim 8, wherein the second stability system modulator further comprises a hold solenoid and an exhaust solenoid.

11. The air brake system of claim 8, wherein the electronic indicator further comprises a brake lamp switch.

12. The air brake system of claim 8, wherein the means for determining the operability of stability system component further comprises the introduction of pressurized air into the stability system component, and wherein the introduction of the pressurized air into the stability system component creates detectable feedback.

13. An air brake system for use with a vehicle, comprising:
(a) an antilock braking system component, wherein the antilock brake system component further comprises:
(i) an electronic control unit;
(ii) at least one antilock modulator in communication with the electronic control unit; and
(iii) at least one brake in communication with the at least one antilock modulator, wherein the at least one antilock modulator controls the at least one brake in response to commands received from the electronic control unit; and
(b) a stability system component, wherein the stability system component operates in combination with the antilock braking system component to stabilize the motion of the vehicle under predetermined conditions, and wherein the stability system component further comprises:
(i) a first stability system modulator in communication with the electronic control unit and the at least one antilock modulator;
(ii) a second stability system modulator in communication with the electronic control unit and the first stability system modulator; and
(iii) an electronic indicator in communication with the electronic control unit; and
(c) a means for determining the operability of stability system component, wherein the means for determining the operability of stability system component provides at least one of an audible indicator and an electronic indicator, and wherein the means for determining the operability of stability system component further comprises:
(i) introducing pressurized air into stability system component;
(ii) generating feedback within stability system component by selectively energizing and de-energizing the at least one antilock modulator, the first stability system modulator, and the second stability system modulator in a predetermined sequence;
(iii) analyzing the feedback with the electronic control unit to determine the operability of stability system component; and
(iv) using the electronic indicator to the display the results of the feedback analysis.

14. The air brake system of claim 13, further comprising an means for determining the operability of the antilock braking system component, and wherein the means for determining the operability of stability system component works in combination with the means for determining the operability of the antilock braking system component.

15. The air brake system of claim 13, wherein the second stability system modulator further comprises a hold solenoid and an exhaust solenoid.

16. The air brake system of claim 13, wherein the electronic indicator further comprises a brake lamp switch.

17. A method for diagnosing the operability of a vehicle stability system, comprising:
(a) introducing pressurized air into stability system, wherein the stability system comprises:
(i) an electronic control unit;
(ii) at least one antilock modulator in communication with the electronic control unit;
(iii) at least one stability system modulator in communication with the electronic control unit and the at least one antilock modulator; and
(iv) an electronic indicator in communication with the electronic control unit; and
(b) generating feedback within stability system component by selectively energizing and de-energizing the at least one antilock modulator, the first stability system modulator, and the second stability system modulator in a predetermined sequence, wherein the selective energizing and de-energizing of the modulators generates an audible indicator of system operability;
(c) analyzing the feedback with the electronic control unit to determine the operability of stability system component; and
(d) using the electronic indicator to the display the results of the feedback analysis.

18. The method of claim 17, further comprising implementing a means for determining the operability of the antilock braking system component, and wherein the means for determining the operability of stability system component works in combination with the means for determining the operability of the antilock braking system component.

19. The method of claim 17, wherein the second stability system modulator further comprises a hold solenoid and an exhaust solenoid.

20. The method of claim 17, wherein the electronic indicator further comprises a brake lamp switch.
